(19) United States
(12) Patent Application Publication
(10) Pub. No.: US 2013/0138353 A1
(43) Pub. Date: May 30, 2013

(54) METHOD AND SYSTEM FOR DETECTING REGULATORY SINGLE NUCLEOTIDE POLYMORPHISMS

(71) Applicants: Geoff Macintyre, Eveleigh (AU); Adam Kowalczyk, Glen Waverley (AU); Izhak Haviv, Caulfield (AU); James Bailey, Eveleigh (AU)

(72) Inventors: Geoff Macintyre, Eveleigh (AU); Adam Kowalczyk, Glen Waverley (AU); Izhak Haviv, Caulfield (AU); James Bailey, Eveleigh (AU)

(21) Appl. No.: 13/640,021

(22) PCT Filed: Apr. 12, 2011
(86) PCT No.: PCT/AU11/00420

§ 371 Date: Jan. 31, 2013

(30) Foreign Application Priority Data
Apr. 12, 2010 (AU) 2010901540
Jul. 9, 2010 (AU) 2010903060

(51) Int. Cl. G06F 19/22; G06F 17/18

(52) U.S. Cl. CPC G06F 19/22; G06F 17/18
USPC 702/19

(57) ABSTRACT

A computer-implemented method for detecting a regulatory single nucleotide polymorphism (rSNP). The method comprises determining a first score representative of a transcription factor binding affinity of a first allele, and a second score representative of a transcription factor binding affinity of a second allele. The first and second alleles are associated with a single nucleotide polymorphism (SNP), and the first score differs from the second score representing a change in the transcription factor binding affinity. A statistical significance value of the change in transcription factor binding affinity represented by the first score and the second score is then determined and compared with a threshold to determine whether the SNP is an rSNP. This disclosure also concerns a computer system and a computer program for detecting a regulatory single nucleotide polymorphism (rSNP).

### CROSS REFERENCE TO RELATED APPLICATIONS

The present application claims priority from Australian Provisional Application No. 2010901540 filed on 12 Apr. 2010 and Provisional Application No. 2010903060 filed on 9 Jul. 2010, the content of both is incorporated herein by reference.

### TECHNICAL FIELD

This disclosure relates generally to bioinformatics, and more particularly a computer-implemented method for detecting regulatory single nucleotide polymorphisms (rSNPs). This disclosure also relates to a computer system and a computer program for detecting rSNPs.

### BACKGROUND

Single nucleotide polymorphisms are changes in one base at a specific position in a DNA sequence. One aim of the Genome-Wide Association Studies (GWAS) is to find single nucleotide polymorphisms (SNPs) that are linked to a particular disease or trait phenotype. Disease associated SNPs residing in coding regions, specifically non-synonymous mutations, are generally easy to interpret in terms of their functional impact.

However, unraveling the functional impact of SNPs residing outside of coding regions is more challenging. One possible functional role for non-coding disease associated SNPs is that they are rSNPs. That is, they alter the binding affinity of a transcription factor to the DNA, which in turn alters the expression of certain genes, consequently contributing to the disease phenotype. Finding these rSNPs is difficult, since they can be obscured by the potentially large number of SNPs present in a linkage-disequilibrium block, and the experimental procedures involved can be expensive and labour intensive.

### SUMMARY

According to a first aspect, there is provided a computer-implemented method for detecting a regulatory single nucleotide polymorphism (rSNP), comprising:
(a) determining a first score representative of a transcription factor binding affinity of a first allele, and a second score representative of a transcription factor binding affinity of a second allele,
wherein the first and second alleles are associated with a single nucleotide polymorphism (SNP), and the first score differs from the second score representing a change in the transcription factor binding affinity;
(b) determining a statistical significance value of the change in transcription factor binding affinity represented by the first score and the second score; and
(c) comparing the statistical significance value with a threshold to determine whether the SNP is an rSNP.

Using the computer-implemented method (i.e. in silico) above, candidate rSNPs can be determined more efficiently compared to experimental procedures. By using the statistical significance value of the change in transcription factor binding affinity to detect rSNPs, the method provide significant sets of predicted disrupted TF binding sites and significance scores of results across a large number of SNPs. Advantageously, the method yields prediction with statistical significance and is therefore suitable for high throughput screening of SNPs for potential regulatory function. This is a useful and important tool in the interpretation of GWAS.

The statistical significance value of the change in transcription factor binding affinity in step (b) may represent a statistical significance of observing a ratio between a statistical significance value of the first score and a statistical significance value of the second score.

The statistical significance of observing the ratio may be determined, using a distribution of ratios of statistical significance values of all scores. In this case, the method further comprises calculating or retrieving the distribution of ratios of statistical significance values of all scores prior to step (b). The first score may be greater than the second score in steps (a) and (b).

Alternatively; the statistical significance value of the change in transcription factor binding affinity in step (b) may represent a statistical significance of observing the first score and the second score on a two-dimensional, joint distribution of first and second scores. In this case, the method may further comprise calculating the two-dimensional, joint distribution of first and second scores prior to step (b).

The two-dimensional joint distribution may be calculated using mutation probabilities representative of biases of mutation preferences from the first allele to the second allele. In this case, the mutation probabilities may follow a probability distribution of observing the second allele. Alternatively, the mutation probabilities may follow a probability distribution with equal probabilities of observing different nucleotides.

The two-dimensional, joint distribution may also capture statistical similarity of the first score and the second score.

The distribution of scores or the joint distribution of scores may be calculated using direct computation or convolution. The distribution may be calculated recurrently using multiple iterations where a partial sum of the distribution is calculated at each iteration.

Step (b) may be performed only if the higher value between a first statistical significance value of the first score and a second statistical significance value of the second score satisfies a predetermined threshold of statistical significance.

The first and second scores may each be determined using a position weight matrix (PWM) associated with the first and second alleles. In this case, the first score and the second score may be determined using a sum of weights, each weight is associated with a base at a position in the first or second allele. The weights may be absolute frequencies of the base at the position, relative frequencies or a transformation of the absolute or relative frequencies.

The method may further comprise repeating steps (a), (b) and (c) for one or more other pairs of first and second alleles, and ranking each pair of first and second allele according to respective statistical significance value of the change in transcription factor binding affinity.

According to a second aspect, there is provided computer program to implement the method according to the first aspect. The computer program may be embodied in a computer-readable medium such that when code of the computer program is executed, causes a computer system to implement the method.

According to a third aspect, there is provided a computer system for detecting a regulatory single nucleotide polymorphism (rSNP), comprising a processing unit operable to:
(a) determine a first score representative of a transcription factor binding affinity of a first allele, and a second score representative of a transcription factor binding affinity of a second allele,
wherein the first and second alleles are associated with a single nucleotide polymorphism (SNP), and the first score differs from the second score representing a change in the transcription factor binding affinity;
(b) determine a statistical significance value of the change in transcription factor binding affinity represented by the first score and the second score; and
(c) compare the statistical significance value with a threshold to determine whether the SNP is an rSNP.

### BRIEF DESCRIPTION OF DRAWINGS

Non-limiting example(s) of the computer-implemented method and computer system for detecting regulatory SNP will now be described with reference to the accompanying drawings, in which:

FIG. 1 is a schematic diagram of an exemplary computer system for implementing a method for detecting rSNPs.

FIG. 2(a) is a logo for a position weight matrix (PWM) of a transcription factor of OCT1.

FIG. 2(b) is a PWM of OCT1.

FIG. 2(c) shows two binding sites for OCT1 containing a SNP: Allele 1 (A1) with position 8=T and Allele 2 (A2) with position 8=C.

FIG. 3 is a flowchart of steps performed by the processing unit in FIG. 1 for detecting rSNPs.

FIG. 4(a) is a flowchart of a ratio method for performing step 330 in FIG. 3.

FIG. 4(b) is a flowchart of a joint distribution method for performing step 330 in FIG. 3.

FIG. 5(a) is a graph of a distribution of scores generated by OCT1 PWM and the scores for first (A1) and second (A2) alleles.

FIG. 5(b) is a graph of a distribution of ratios of scores and log scale y axis of frequency.

FIG. 6(a) is a graph of a distribution of scores generated by OCT1 PWM and the scores for first (A1) and second (A2) alleles.

FIG. 6(b) is a graph of a joint distribution (2-dimensional) of observed calibrated scores for the first allele and second allele on a negative log scale. The dot represents the observed scores for the first allele and second allele for a worked example. The shaded area includes the scores used for calculation of the p-value of the change in scores using the joint distribution method in FIG. 4(b).

FIG. 6(c) is a graph of a joint distribution (2-dimensional) of observed calibrated scores for the first allele and second allele on a negative log scale. The dot represents the observed scores for the first allele and second allele for the worked example. The shaded area includes the scores used for calculation of the p-value of the change in scores using the ratio method in FIG. 4(a).

FIG. 7(a) is a table of the results of applying the ratio method to four known regulatory SNPs.

FIG. 7(b) is a figure of box plots comparing the results of applying the ratio method in FIG. 4(a), the joint distribution method in FIG. 4(b) and sTRAP to some known regulatory SNPs.

FIG. 8 is a table providing a summary of the results output when one example of the is-rSNP method is used to identify candidate regulatory SNPs in a set of intergenic disease associated SNPs.

### DETAILED DESCRIPTION

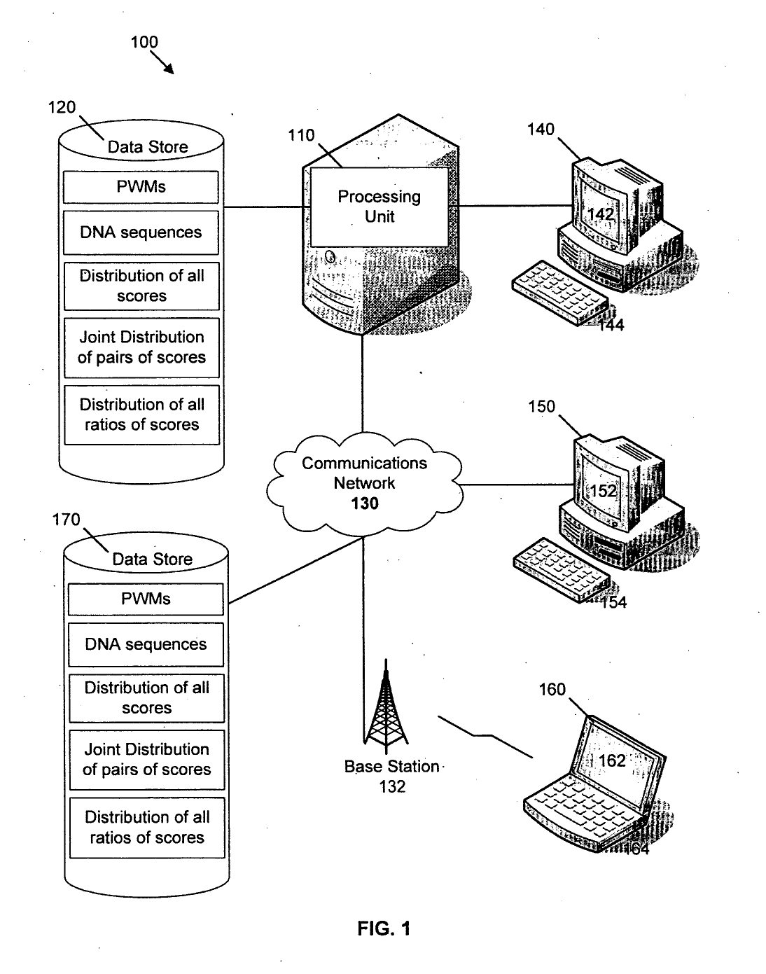

Referring first to FIG. 1, a computer system 100 for performing a computer-implemented (i.e. in silico) method for detecting rSNPs comprises a processing unit 110 and data store 120. SNP occurs at a polymorphic site occupied by a single nucleotide, which may alter the function of deoxyribonucleic acid (DNA), ribonucleic acid (RNA) and proteins. rSNP is a type of SNP that falls in regulatory regions of genes, where a single base change between two individuals affects the binding affinity of a transcription factor (TF) which in turns affects the expression of a gene.

The processing unit 110 may be operated using a local computing device 140 such as one located in a laboratory. The local computing device 140 is operated by a user (not shown for simplicity) and operable to receive input data from a data entry device 144, and to display output data using a display screen 142. In another example, the method for detecting rSNPs can be offered as a web-based tool accessible by remote computing devices 150, 160 each having a display screen 152, 162 and data entry device 154, 164. In this case, the remote computing devices 150, 160 are capable of sending and receiving data from the processing unit 110 via a wide area communications network 130 such as the Internet and where applicable, a wireless communications network comprising a wireless base station 132.

The processing unit 110 is also operable to retrieve relevant data from a local data store 120, or from a remote data store 170 accessible via the communications network 130. The relevant data include DNA sequences and associated position weight matrices (PWMs), distribution of scores, distribution of ratios of scores, and joint distribution of scores, which will be discussed further below.

As an example, the method will be explained using a rSNP that is known to violate an OCT-binding sequence (Demars et. al., 2010). The TF binding site reported to be violated by the rSNP is bound by OCT4. There is, however, no PWM for OCT4 in TRANSFAC. In this case, PWMs for any of the OCT proteins will be considered to be a positive match, as they generally have similar DNA recognition sites. A positive PWM hit is considered to match any protein with the family (i.e. a positive hit for a STAT1 binding protein could be a PWM for STAT3). The PWM for OCT1 will be used.

### Position Weight Matrix (PWM)

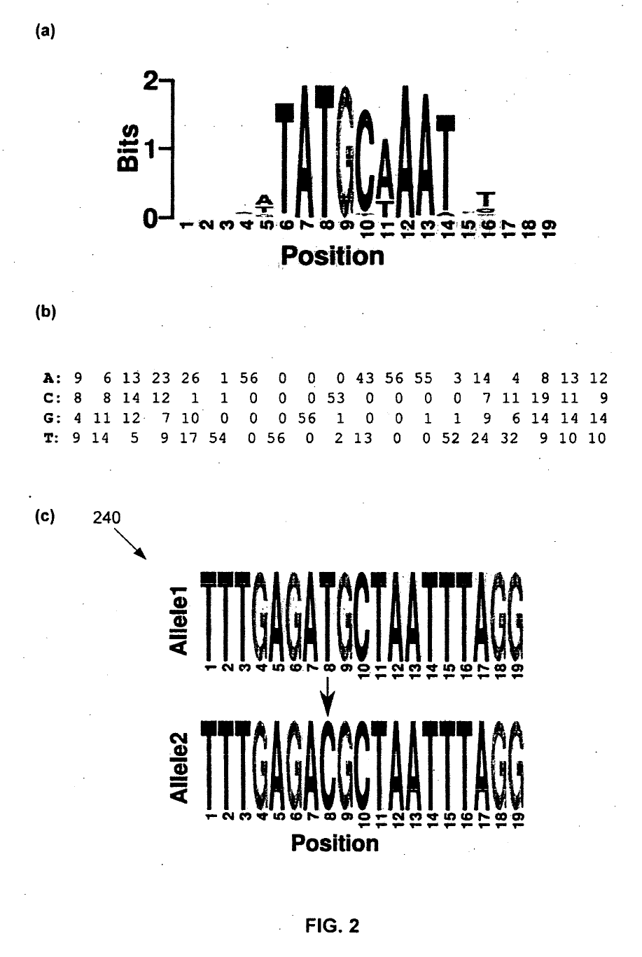

FIG. 2(a) shows the graphical representation 200 of a PWM for OCT1. This is known as a logo (Crooks et al., 2004) and represents the set of DNA binding sites recognised by OCT1. The height at each position represents the conservation of that position in terms of bits and the height of each letter represents the frequency of observing that base in that position in the binding site.

Referring also to FIG. 2(b), a PWM that corresponds to the logo in FIG. 2(a) is a matrix:

w=[w(k,i)]_{4×n}

Each column i=1, . . . , n of the PWM corresponds to a position in the matrix, in order of the first position to the last position, i.e. n=19. Each row k=1, . . . , 4 of the PWM corresponds to one of the four nucleotides or bases found in DNA, in the order of Adenine (A), Cytosine (C), Guanine (G) and Thymine (T).

The weight w(k, i) corresponds to the number of times that a given nucleotide has been observed at a given position i. For example, position i=8 always has a T whereas position i=11 may have an A or T. The corresponding weight w(4, 8) of observing a T in this position is 56 whereas w(1, 8), w(2, 8), and w(3, 8) are zero respectively. As for position 11, the corresponding scores w(1, 11) and w(4, 11) are 43 and 13 respectively. Position 8 is said to be absolutely conserved. It will be appreciated that although absolute frequencies (i.e. number of times) are used in FIG. 2(b), other weight representations may also be used, such as relative frequencies or a transformation (such as log-odds) of the matrix.

FIG. 2(c) shows the sequences for a regulatory SNP associated with fetal growth disorder. Regulatory SNPs that change a base at a conserved position are much more likely to disrupt TF binding than those that change a base at a less conserved position. As the conservation at each base is encapsulated in a PWM, scoring each allele with a PWM allows observation of the change in score and hence the change in binding affinity of the TF.

In FIG. 2(c), the top sequence is labelled Allele1 (A1) and the bottom sequence labelled Allele 2 (A2) is mutated at position 8 in the disease. In (Demars et. al., 2010), OCT4 is shown to be bound to A1, but not bound in A2. This change at position 8 from T to a C changes the score for OCT1 at position 8 from w(4, 8)=56 to w(1, 8)=0.

### Algorithm

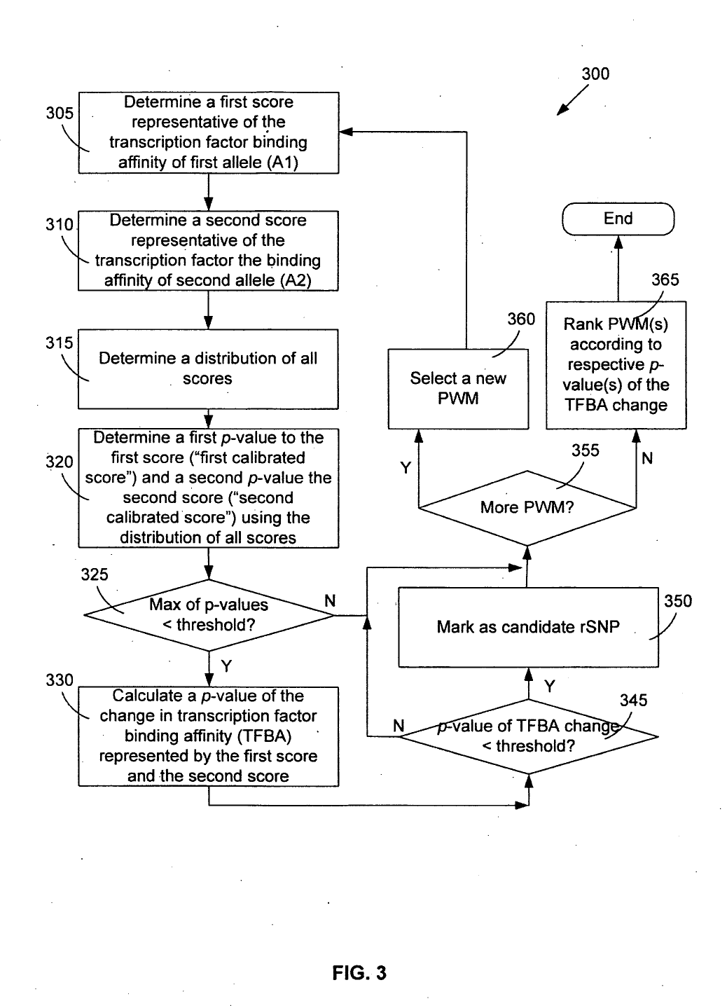

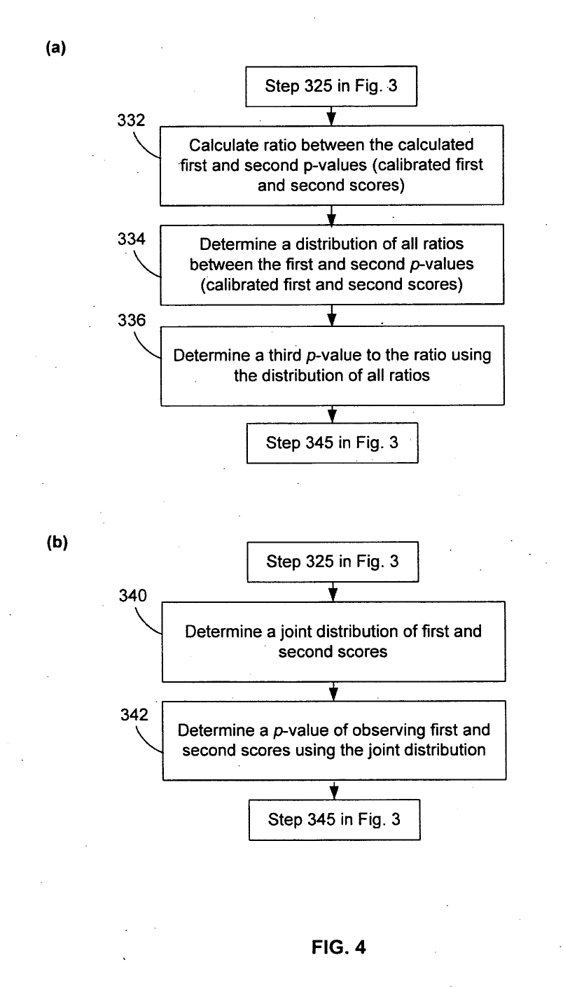

For an input SNP and corresponding PWM, the processing unit 110 performs the steps in FIG. 3 to detect whether the input SNP is a candidate regulatory SNP. The processing unit 110 also performs the steps in either FIG. 4(a) or FIG. 4(b) to determine the statistical significance of the change in score, and hence the change in transcription factor binding affinity. Throughout this description, the method will be referred to as “is-rSNP”, i.e. in silico regulatory SNP detection.

First, in step 305, the processing unit 110 determines a first score representative of the transcription factor binding affinity for first allele A1. Similarly in step 310, a second score representative of the transcription factor binding affinity for second allele A2 is calculated. It should be understood that the term “determining” here, and throughout the description, includes the processing unit 110 performing a calculation of a value, or where appropriate, extracting or retrieving a pre-computed value from the data store 120.

The respective score Sₙ(\vec{b}) for alleles A1 and A2 is calculated as follows:

$${S}_{n} ( \vec{b} ) := {\sum }_{i = 1}^{n} w ( {b}_{i} , i ) \qquad ( 1 )$$

for the n-tuple \hat{b}=(b₁, . . . , bₙ)ε [symbol] ⁿ, where [symbol] :={1, 2, 3, 4}≡={A, C, G, T} represents the space of four DNA bases and n=19. Assuming a prior probability distribution p(b), b=1, . . . , 4 on [symbol] and each nucleotide is sampled independently from [symbol] , the score Sₙ(\vec{b}) can be viewed as a random variable (RV) on [symbol] with the product probability distribution.

For the SNP shown in FIG. 2(c), the change from base T in allele A1 to base C in allele A2 changes the PWM score for OCT1 from 550 to 495, as calculated below using Eq. (1) and the PWM in FIG. 2(b):

S(A1)=w(T,1)+w(T,2)++w(T,8)++w(G,19)=550

S(A2)=w(T,1)+w(T,2)++w(C,8)++w(G,19)=495.

While these scores do not mean much on their own, the statistical significance of the score can be determined by looking at the entire distribution of scores. In step 315 in FIG. 3, the processing unit 110 calculates a distribution of all scores generated by the PWM, or alternatively, retrieves a pre-calculated distribution from the data store 120. The distribution can then be used to determine a p-value of a score in the next step.

More specifically, in step 320, the processing unit 110 then determines a first p-value (P1) representing the statistical significance of the first score Sₙ(A1) and a second p-value (P2) representing the statistical significance of the second score Sₙ(A2) using the distribution to obtain:

P1=P[Sₙ≧Sₙ(A1)]; and

P2=P[Sₙ≧Sₙ(A2)],

where Sₙ is a random variable on [symbol] ⁿ. The p-value represents the probability of obtaining a random value that is at least as extreme as the score observed, and therefore the rank of the score within the distribution of all scores.

The processing unit 110 then performs an optional filtering process. If the higher score out of the p-values P1 and P2 is statistically significant, i.e. less than a threshold (P<0.001), then the TF represented by the PWM is considered likely to be bound; see step 325. Otherwise, the processing unit 110 proceeds to step 355, in which a new PWM is considered and steps 305 to 325 are repeated.

In step 330, the processing unit 110 then determines the statistical significance of the change in transcription factor binding affinity to detect whether the SNP is an rSNP. The statistical significance of the change in transcription factor binding affinity can be determined using two methods as follows:
(1) In a “ratio method” exemplified using FIG. 4(a), the statistical significance of the change in transcription factor binding affinity represents the statistical significance of observing a ratio between the p-values P1 and P2 of the respective first score Sₙ(A1) and second score Sₙ(A2).
(2) In a “joint distribution method” exemplified using FIG. 4(b), the statistical significance of the change in transcription factor binding affinity represents the statistical significance of observing the first and second scores [Sₙ(A1), Sₙ(A2)] on a two-dimensional, joint distribution of first and second scores.

In the particular case when the first score is greater than or equals to the second score Sₙ(A1)≧Sₙ(A2), the “ratio method” is equivalent to computation of the following probability (p-value):

$${P}_{ratio} ( A 1 , A 2 ) = {P}_{B 1 , B 2} [ \frac{P [ {S}_{n} \geq {S}_{n} ( B 2 ) ]}{P [ {S}_{n} \geq {S}_{n} ( B 1 ) ]} \geq \frac{P [ {S}_{n} \geq {S}_{n} ( A 2 ) ]}{P [ {S}_{n} \geq {S}_{n} ( A 1 ) ]} ] .$$

Here alleles (B1,B2) are sampled form the space of all possible n-tuples of nucleotides and their single base mutations. The “joint distribution method” above corresponds to computation of the following joint probability (see also Eq. (14) below):

pⱼₒᵢₙₜ(A1,A2)=P_{B1,B2}[[Sₙ(B1)≧Sₙ(A1)] & [Sₙ(B2)≦Sₙ(A2)]].

In step 345, the processing unit 110 then compares the determined statistical significance with a threshold to detect whether the SNP is an rSNP. The processing unit 110 then checks whether there are more scores to be analysed in the data store 120; see step 355 in FIG. 3. If yes, the processing unit 110 selects a new PWM and repeats the steps for this new score; see step 360. Otherwise, the processing unit 110 proceeds to rank the analysed PWM(s) according to the calculated p-value of change in transcription factor binding affinity; see step 365.

Step 315 and step 330 using the ratio method in FIG. 4(a) or the joint distribution method in FIG. 4(b) will be explained in further detail below.

### Generating the Distribution of all Scores (Step 315)

In Step 315 in FIG. 3, the processing unit 110 determines a distribution of PWM scores, p*(x)=P[Sₙ≧x] based on a PWM w=[w(k, i)]₄ₓₙ and its score Sₙ(\vec{b}) according to Eq. (1) is calculated.

With a rounding and appropriate affine transformation of the weights, the computation of the distribution of Sₙ is reducible to the special case of non-negative integer weights w(k, i) of the limited magnitude. In general, the computation of the distribution of (1) is known to be a NP-hard problem, subsuming the standard NP-hard benchmark of “sum of the set” (Touzet and Varre, 2007). However, in our special case of integer values of finite magnitude it has linear complexity (Pisinger, 1999) and this is what is being leveraged here.

The efficient computation of the distribution of the scores in Eq. (1) is feasible if the weights w have regularly spaced discrete values:

w(k,i)=εz

where z is an integer and ε>0. This is achieved by rounding w(k, i) with granularity c, see (Touzet and Varre, 2007) for a discussion of some issues which could be caused by rounding.

After rounding further simplifications are possible. By replacing w(k, i) with positive integer w⁽²⁾(k, i):=(w(k, i)−C)/ε, where C:=min_{k,i}w(k, i), the original score Sₙ computed by Eq. (1) is replaced by the integer value score:

$${S}_{n}^{( 2 )} := {\sum }_{i = 1}^{n} {w}^{( 2 )} ( k , i ) = \frac{{S}_{n} + nC}{ε} ∈ \{ 0 , 1 , 2 , … , nU \} ,$$

where U:=max_{k,i}w⁽²⁾(k, i) The above simple affine relation means that the distributions of Sₙ and Sₙ⁽²⁾ are trivially related and consequently the general problem of computing distribution of scores can be reduced to a special case with the following integer weights without loss of generality:

w(k,i)ε{0,1,2, . . . ,U},

Note that in such a case Sₙ attains values between 0 and

$${U}^{*} := {\sum }_{i = 1}^{n} {max}_{k} w ( k , i ) \leq nU . \qquad ( 2 )$$

Now the distribution of RV Sₙ can be determined using:

$${p}_{* , n} ( x ) := P [ {S}_{n} = x ] = {\sum }_{\vec{b}} p ( {b}_{1} ) p ( {b}_{2} ) … p ( {b}_{n} ) , \qquad ( 3 )$$

xε{0, 1, 2, . . . , U*}, the sum is over all \vec{b}=(bᵢ)ε [symbol] ⁿ such that

w(b₁,1)+ . . . +w(bₙ,n)=x,

and p_{*,n}(x):=0, if no such \vec{b} exists. It is recognised that Eq. (3) describes the convolution of n distribution p on [symbol] .

The sum in Eq. (2) involves 4ⁿ terms, which in the case of larger motifs, say n=30, results in the number 4ⁿ≈10¹⁸ of terms being too many for a naive, direct computation. However, the whole evaluation simplifies if performed recurrently using multiple iterations. Namely, at each iteration, the distribution of the partial sum of the first j terms, for 2≦j≦n, is calculated as follows:

$${p}_{* , j} ( x ) = {\sum }_{b ∈ 𝔹} p ( b ) {p}_{* , j - 1} ( x - w ( b , j ) ) . \qquad ( 4 )$$

This allows for efficient evaluation of p_{*,n} by finding first all intermediate distributions p_{*,n}, j=1, . . . , n−1. The explicit algorithm is presented as follows:

Algorithm 1: Computation of the distribution of PWM scores, p_{*}(x) =
P[Sₙ ≧ x]

```
Given:
1.  A prior probability distribution [p(b)] on [symbol]   := {1, 2, 3, 4};
2.  A PWM [w(b,i)]_{4×n} with non-negative integer values ≦ U.
Initialise the U*-vector p_{*}:
3.  p_{*}(x) := 0 for x = 0, 1, ..., U*.
4.  for b = 1 : 4
5.  set p_{*}(w(b, 1)) ← p_{*}(w(b, 1)) + p(b);
6.  }
7.  for i = 2 : n
8.  set p_{*0}(x) = 0 for x = 0, 1, ..., U*;
9.  for x = 0 : min ((i − 1)U,U*)
10.  for b = 1 : 4
11.  set p_{*0}(x + w(b,i)) ← p_{*0}(x + w(b,i)) + p_{*}(x)p(b);
        }
      }
12.  set: p_{*} = p_{*0};
    }
Output:  p_{*}.
```

The whole computation can be performed with ≦2n(U+1)(n+2) multiplications and twice as many additions and with minimal memory requirement of n(U+1) registers for the storing the values of the distribution.

(1) Ratio Method in FIG. 4(a)

In the ratio method, the statistical significance of the change in transcription factor binding affinity is determined using the entire distribution of scores generated by the PWM and the distribution of ratios of first and second scores.

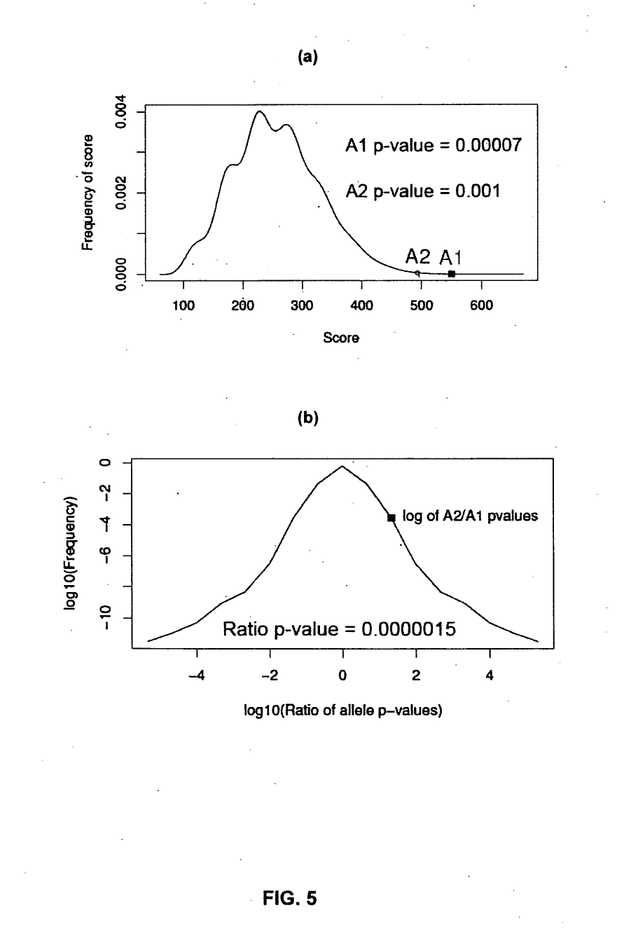

FIG. 5(a) shows the respective p-value of A1 and A2 on the distribution of observed scores calculated or retrieved in step 315. Allele A1 with base T at position 8 resides in the tail of the distribution of observed scores and is therefore likely to be bound by OCT1. The probability of observing a higher score is P<0.0001. The probability of observing a higher score than allele A2 is an order of magnitude less at P<0.001. The statistical significance of the score difference can be tested statistically as follows.

Referring now to FIG. 4(a), the processing unit 110 calculates a relationship between the two p-values, in the form of a ratio between the two p-values, i.e. P1/P2; see step 332. The processing unit 110 then calculates the distribution of all ratios for the given PWM, or alternatively retrieves the distribution from the data store 120; see step 334. Then, based on the distribution of all ratios, the processing unit 110 determines or allocates a third statistical significance value P3 in step 336:

$$P 3 = P [ Δ p \geq \frac{P [ {S}_{n} \geq {S}_{n} ( A 1 ) ]}{P [ {S}_{n} \geq {S}_{n} ( A 2 ) ]} ] ,$$

where Δp is a random observation of the ratio between two p-values. P3 represents the p-value to the relationship between the two p-values in the form of ratio P1/P2 and can be expressed as a “log-rank” function.

As the p-value for each score is representative of the rank of the score within the distribution of all scores, the ratio of the p-values can be taken as a measurement of the difference or change in binding affinity between two alleles. Furthermore, the distribution of all ratios of p-values for all possible SNPs can be used to determine the statistical significance of the observed ratio (probability of observing a higher ratio).

If the p-value P3 of the ratio between the two p-values is significant compared to a random case, i.e. less than a threshold (e.g. P<0.01), then the current SNP is marked as a candidate rSNP; see steps 345 and 350 in FIG. 3. In the example in FIG. 5(b), the observed ratio has a p-value of 0.0000015. In this case, it can be concluded that the difference is statistically significant and an OCT1 binding site is violated by this SNP.

Referring to FIG. 3 again, the processing unit 110 then checks whether there are more PWMs to be analysed in the data store 120; see step 355. If yes, the processing unit 110 selects a new PWM and repeats steps 305 to 325 for this new PWM; see step 360.

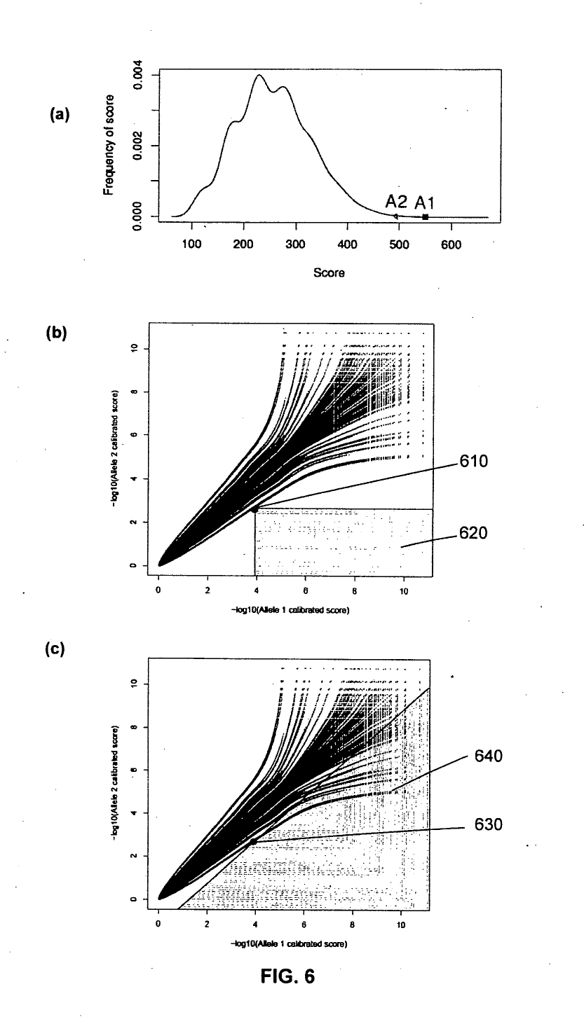

Otherwise, the processing unit 110 proceeds to rank the analysed PWM(s) according to the calculated p-value of the ratio between the p-value of the first score and the p-value of the second score; see step 365. An exemplary list of ranked results generated according to step 365 is shown in Table 1 in FIG. 6(a), which will be explained further in a subsequent section.

It will be appreciated that given a PWM for a TF, if it is assumed that the current SNP under consideration is an rSNP, the most likely position in which the TF is bound across the SNP is determined. Therefore, the method uses a sliding window approach to step across the SNP at each position equal to the width n of the PWM, and considering the maximum score output by the PWM to be the likely binding site. For each window encompassing the SNP, the change in the affinity of binding according to the preselected PWM is calculated, and the statistical significance of this change is estimated:

In general terms, given a fixed PWM, steps 305 to 320 serve to “calibrate” the scores of alleles A1 and A2. The calibration consists in allocation of a “rank” to each score in the sequence of all possible PWM scores (for every possible setting for the DNA sequence), sorted from the highest to the lowest value. Next in steps 330 to 340, given two scores for different values of the SNP base, the ratio of these ranks is calculated. This ratio is again rank-calibrated in the space of all possible such ratios for the PWM in question and for all possible SNP variations. This final rank is converted to the value between 0 and 1, by dividing it by the total number of such ratios.

It will be appreciated that the above procedure may be adjusted to take into account the biases in the distribution of bases. The simple counting procedures need to be replaced by the respective cumulative distributions, equivalent to the counting in the uniform case. Also, due to the large number of possible base combinations and some of the small values of extreme probabilities, it is convenient to use logarithms, so the ratio to rank calibrated ranked-scores becomes a difference of logs of cumulated probabilities. These are some minor issues, the major challenge is design a computational procedure which allow for robust quantification of the tails of distributions in question, which cannot by computed directly by naive implementation or even estimated by Monte-Carlo simulation. In the above example, it has been shown that they are computable in a rigorous, though indirect form.

### (1)(a) Generating the Distribution of the Ratio of Two Calibrated PWM Scores (Step 235)

Step 335 in FIG. 3 will be further explained below, in which the processing unit 110 calculates a distribution of ratios of PWM scores pΔ(v):=P[[Δρ]_{δ}=v].

Knowledge of the distribution of S allows the scores to be calibrated using their p-values P[Sₙ≧x]. This is a form of ranking of all the possible score values, from the highest to the lowest, accounting for the varying probability of different scores being attained with different frequency. Introducing the following “log-rank” function for any xε{0, 1, . . . , U*}:

$$ρ ( x ) := - {log}_{10} P [ {S}_{n} \geq x ] = - {log}_{10} {\sum }_{ξ = x}^{{U}^{*}} {p}_{* , n} ( ξ ) , \qquad ( 6 )$$

For clarity, ‘′’ and ‘″’ mark first and second alleles respectively. In the case of SNP changing the i-th nucleotide bᵢ of \vec{b} to b′, we may observe a significant change in the score (1) from Sₙ(\vec{b}) to

$$\begin{matrix}{S}_{n}^{( i )} ( \vec{b} , {b}^{″} ) := {S}_{n} ( ( {b}_{1} , … , {b}_{i - 1} , {b}^{″} , {b}_{i + 1} , … , {b}_{n} ) ) \\ = w ( {b}^{″} , i ) + {\sum }_{j \neq i} w ( {b}_{j} , j ) ,\end{matrix} \qquad ( 7 )$$

reflected in the change of log-rank

$${Δρ}_{0} := ρ ( {S}_{n} ( \vec{b} ) ) = ρ ( {S}_{n}^{( i )} ( \vec{b} , {b}^{″} ) ) = - {log}_{10} \frac{P [ {S}_{n} \geq {S}_{n} ( \vec{b} ) ]}{P [ {S}_{n} \geq {S}_{n}^{( i )} ( \vec{b} , {b}^{″} ) ]} ,$$

The change may signify a regulatory SNP, but the change needs to be calibrated in order to assess its significance. Specifically, the distribution of the RV of all possible single base changes is evaluated:

Δρ(\vec{b},i,b′,b″)=ρ(Sₙ⁽ⁱ⁾(\vec{b},b′))−ρ(Sₙ⁽ⁱ⁾(\vec{b},b″)),

where nucleotides bⱼ, b′ and b″ are drawn independently from [symbol] according to our prior distribution and position i is drawn uniformly from {1, . . . , n}.

Note that for every bε [symbol] , we have

$$\begin{matrix}P [ Δρ = v ] := \frac{1}{n} {\sum }_{i = 1}^{n} {\sum }_{{b}^{′} , {b}^{″} ∈ 𝔹} {\sum }_{x} p ( {b}^{′} ) p ( {b}^{″} ) P [ {\sum }_{j \neq i} w ( {b}_{j} , j ) = x ] \\ = \frac{1}{n} {\sum }_{i = 1}^{n} {\sum }_{{b}^{′} , {b}^{″} ∈ 𝔹} {\sum }_{x} p ( {b}^{′} ) p ( {b}^{″} ) {p}_{* , n \backslash i} ( x ) ,\end{matrix} \qquad ( 7 )$$

where the third sum is over values xε{0, 1, . . . , min((n−1)U,U*)} such that

ρ(x+w(b′,i))−ρ(x+w(b″,i))=v,

and p_{*,n\i} is the distribution of scores of Σ_{j≠i}w(bⱼ,j) of the PWM with ith column neglected, which can be easily computed by a straightforward adaptation of the recurrence (4). Note that the probability is set to zero if no such x exists.

The algorithm below computes the distribution of log-rank changes Δρ with granularity δ>0. The RV Δρ has potentially 16n(n−1)(U+1) continuous values of magnitude ≦A:=−n log₁₀ min_{bε} [symbol] p(b). It is practical to aggregate them by rounding with granularity δ>0 into the maximum of 2V+1 values, where:

$$V := ⌈ \frac{A}{δ} ⌉ = ⌈ \frac{- n {log}_{10} {min}_{b ∈ 𝔹} p ( b )}{δ} ⌉$$

Denoting [x]_{δ} the rounding of x/δ to nearest integer xε [symbol] , the final formula for distribution of the discrete RV (\vec{b},i,b′,b″) [symbol] [Δρ]_{δ}:

$$p Δ ( υ ) := P [ {[ Δρ ]}_{δ} = υ ] = \frac{1}{n} {\sum }_{i = 1}^{n} {\sum }_{{b}^{′} , {b}^{″} ∈ 𝔹} {\sum }_{x} p ( {b}^{′} ) p ( {b}^{″} ) {p}_{* , n \backslash i} ( x ) \qquad ( 8 )$$

for vε[−V:V]:={−V, −V+1, . . . , V−1, V}, where the third sum is over all x such that [ρ(x+w(b′,i))−ρ(x+w(b″,i))]_{δ}=vδ. The following algorithm describes the computation of this distribution.

Algorithm 2: Computation of distribution of ratios of calibrated PWM scores
p_{Δ}(υ) := P[[Δρ]_{δ} = υδ]

Given:

| | |
|---|---|
| 1. | $A prior probability distribution [ p ( b ) ] on B := \{ 1 , 2 , 3 , 4 \} ;$ |
| 2. | A PWM [w(b, i)]_{4×n} with non-negative integer values ≦ U; |
| 3. | A constant δ > 0. |

Initialisation:

| | |
|---|---|
| 4. | Use Algorithm 1 to compute distribution [p_{*,n}(x)]_{x=0,1, . . . ,U*} of scores |
| | Sₙ = Σⱼ₌₁ⁿ w(b, j); |
| 5. | Set ρ(x) = −log₁₀ p_{*,n}(x) for x = 0, 1, . . . , U*; |
| 6. | $Set V := ⌈ - \frac{n}{δ} {log}_{10} {min}_{b ∈ B} p ( b ) ⌉ .$ |
| 7. | Set p_{Δ}(v) = 0 for υ ε [−V : V]. |
| 8. | for i = 1 : n |
| 9. | Use Algorithm 1 to compute the distribution [p_{*,n/i}(x)]_{x=0,1, . . . ,U*} of |
| | scores Σ_{j≠1} w(bⱼ, j) of the reduced PWM with ith column neglected; |
| 10. | for b′ = 1 : 4 |
| 11. | for b″ = b′ : 4 |
| 12. | for x = 0 : min ((n − 1)U, U*) |
| 13. | v = [ρ(x + w(b′, i)) − ρ(x + w(b″, i))]_{δ}; |
| 14. | set p_{Δ}(v) ← p_{Δ}(v) + p(b′)p(b″)p_{*,n\i}(x); |
| 15. | set p_{Δ} (−v) = p_{Δ}(v); |
| | } |
| | } |
| | } |
| | } |

Output: p_{Δ} ← p_{Δ}/n.

For δ=0.01 and the whole TRANSFAC v2009.4 database of approximately 1300 PWMs, this computation can be completed in under four hours on a single CPU machine and only needs to be computed once. Note that sparse representation of vectors in the above algorithms can be used to save the required storage space.

(2) Joint Distribution Method in FIG. 4(b)

In the joint distribution method, the distribution of all scores calculated or retrieved in step 315 by the processing unit 110 in FIG. 3 is extended to a 2-dimensional, joint distribution of PWM scores for the first allele A1 (labelled ‘′’) and second allele A2 (labelled ‘″’).

The joint distribution allows for a more principled and also more “natural” and intuitive way of introduction and justification of the impact of single nucleotide change on a PWM score. In this case, the statistical significance of the change in transcription factor binding affinity according to step 330 in FIG. 3 is determined using the following steps shown in FIG. 4(b):
determining a joint distribution of scores in step 340, and
determining the p-value of observing the score of A1 and the score of A2 using the joint distribution in step 342.

Referring to FIG. 3 again, the processing unit 110 then compares the p-value determined in step 342 with a threshold in step 345 to detect whether the SNP is an r-SNP. Similar to the ratio method, a sliding window approach is also used to step across the SNP at each position equal to the width n of the PWM. The processing unit 110 then checks whether there are more PWMs to be analysed in the data store 120; see step 355. If yes, the processing unit 110 selects a new PWM and repeats steps 305 to 325 for this new PWM; see step 360. Otherwise, the processing unit 110 proceeds to rank the analysed PWM(s) according to the p-value calculated in step 342; see step 365. A list of ranked results is then generated.

FIG. 6(a) shows the observed scores for A1 and A2 for a worked example of matrix OCT1. FIG. 6(b) shows the 2-dimensional, joint distribution of observed possible scores for A1 and A2, given the PWM in FIG. 5. The large dot 610 marks the observed scores for A1 and A2 in the worked example. All scores falling in the shaded region 620 represent those which satisfy the condition in Eq. (14) below, i.e. when the score of A1 is greater than the score of A2. It is these scores which are used generate the p-value associated with the difference in score between A1 and A2 using the 2-dimensional joint distribution method.

FIG. 6(c) uses the joint distribution, to demonstrate the scores used to calculate the p-value in the ratio method (shaded area 640). In this case, the area 640 is much larger than area 620 in FIG. 6(b) therefore the 2-dimensional, joint distribution method according to FIG. 4(b) provides superior p-values over the ratio method according to FIG. 4(a).

### (2)(a) Mutation Matrix

The joint distribution also allows for the introduction of biases in the mutation preferences, i.e, to compute the background distribution under constraints that some substitutions occur more frequently that the others. The mutation matrix is a 4×4 matrix [pₘ(b′,b″)], b′, b″ε [symbol] that is conceptually capturing the mutation probabilities:

$${p}_{m} ( {b}^{′} , {b}^{″} ) := \{ \begin{matrix}P [ {b}^{″} \vert {b}^{′} ] & if {b}^{″} \neq {b}^{′} ; \\ 0 , & otherwise , i . e . when {b}^{′} = {b}^{″} .\end{matrix} \qquad ( 9 )$$

By definition of probability, Σ_{b″}pₘ(b′,b″)=1 for every b″ε [symbol] .

(i) In a first example, the mutation probabilities pₘ may follow a uniform distribution allowing all three substitution with equal probability

$${p}_{m} ( {b}^{′} , {b}^{″} ) := \{ \begin{matrix}1 \text{/} 3 & if {b}^{″} \neq {b}^{′} ; \\ 0 , & otherwise , i . e . when {b}^{′} = {b}^{″} .\end{matrix} \qquad ( 10 )$$

for every b′,b″ε [symbol] .

(ii) In a second example, mutation probabilities pₘ may have the same distribution as for [symbol] and every b″ε [symbol] .

pₘ(b′,b″):=p(b″) (11)

(iii) In a third example, the mutation probabilities may allow all 4 bases with equal probability for b′, b″ε [symbol] .

pₘ(b′,b″):=¼ (12)

The algorithm for calculating the joint distribution for all scores for substitution mutation is as follows:

Algorithm 4 (Distribution of PWM scores for substitution mutation)

```
Given:
1.  A prior probability distribution [p(b)] on [symbol]   := {1, 2, 3, 4};
2.  A mutation distribution [pₘ(b′,b″)], where b′,b″ ε [symbol]   := {1, 2, 3, 4};
3.  A PWM [w(b,i)]_{4×n}, 0 ≦ w(b,i) ≦ U.
Initialise
4.  Set U* = Σᵢ₌₁″ max_{b} w(b,i);
5.  p_{*}(x′,x″) := 0 for x′,x″ = 0, 1, ..., U*.
5.  for i = 1 : n
6.  Use Algorithm 2 to compute the distribution [p_{*0}(x)]_{x=1,2,...,U}₀*,
      U₀* ≦ U*, of scores Σ_{j≠i} w(bⱼ,j) of the reduced PWM
      with i-th column neglected;
8.  for x = 0 : min (U₀*, (i − 1)U)
9.  for b′ = 1 : 4
10.  x′ = x + w(b′,i);
11.  for b″ = 1 : 4
12.  x″ = x + w(b″,i);
13.  set p_{*}(x′,x″) ← p_{*}(x′,x″) + p_{*0}(x′)p(b′)pₘ(b′,b″);
  } }  }  }
Output:  p_{*} ← p_{*}/n.
```

Define the wild type score random variable as:

X′: [symbol] ⁿ→ [symbol] ,X′(\vec{b}′):=Sₙ(\vec{b}′)

with respect to the assumption that nucleotides of \vec{b}′ were iid drawn from [symbol] . Similarly, introducing the mutation random variable:

X″(\vec{b}′,j,b″):=Sₙ^{(j)}(\vec{b}′,b″)=Sₙ((b₁,b₂, . . . ,bⱼ₋₁,b″,bⱼ₊₁, . . . ,bₙ)) (13)

for any (\vec{b}′,j,b″)=((b₁, . . . , bₙ),j,b″)ε [symbol] ⁿ×{1:n}× [symbol] here, where Sₙ^{*j} is defined in Eq. (6).

Assuming that the nucleotides b″ and position of SNP j are drawn independently from [symbol] and [1:n] with the uniform distribution, respectively. The distribution of mutations is governed by the mutation matrix in Eq. (9). More specifically, this means that:

P[B″=b″|\vec{b}′,j]=pₘ(bⱼ,b″),

for any \vec{b}ε [symbol] ⁿ, b″ε [symbol] . and 1≦j≦n.

The following results state that the joint distribution of (X′, X″) is given by p* which can be computed by Algorithm 4.

Theorem 1: Given any x′, x″ε{0, 1, . . . , U*},

P[X′=x′,X″=x″]=p*(x′,x″)

### (2)(b) P-Value for Significant Scores

The p-value for significant scores that are more extreme than observed can be defined as:

$${p}_{val} ( {{b}^{->}}^{′} , {{b}^{->}}^{″} ) := \{ \begin{matrix}P [ {X}^{′} \geq {x}^{′} \& {X}^{″} \leq {x}^{″} ] , & if {x}^{′} \geq {x}^{″} ; \\ P [ {X}^{′} \leq {x}^{′} \& {X}^{″} \geq {x}^{″} ] , & otherwise .\end{matrix} \qquad ( 14 )$$

As before let us define the 2-dimensional matrix [T_{score}(x′,x″)] quantifying the required p-values for x′, x″ε{0, 1, . . . , U*}:

$${\dot{T}}_{score} ( {x}^{′} , {x}^{″} ) := {\sum }_{{x}_{1} = {x}^{′}}^{{U}^{*}} {\sum }_{{x}_{2} = 0}^{{x}^{″}} p * ( {x}_{1} , {x}_{2} ) , \qquad ( 15 )$$

if x′≧x″; and otherwise set:

$${T}_{score} ( {x}^{′} , {x}^{″} ) := {\sum }_{{x}_{1} = 0}^{{x}^{′}} {\sum }_{{x}_{2} = {x}^{″}}^{{U}^{*}} p * ( {x}_{1} , {x}_{2} ) . \qquad ( 16 )$$

Theorem 2: Given a wild type n-mer allele \vec{b}′ε [symbol] ⁿ and its single nucleotide mutation \vec{b}″ε [symbol] ⁿ. Then

pᵥₐₗ(\vec{b}′,\vec{b}″)=T_{score}(Sₙ(\vec{b}′),Sₙ(\vec{b}″)).

### (2)(c) Matrix of Tails

The following algorithm allows for the efficient evaluation of matrix T_{score}, as this could be in practice far more demanding than it looks on a first glance. We state it in a slightly more generic task, of computation of matrix T:=TT(M) given a square matrix, M(i,j) for n₀≦i,j≦n₀+n, where n₀ and n>0 are two integers, using the following definition:

$$T ( i , j ) := \{ \begin{matrix}{\sum }_{k = i}^{{n}_{0} + n} {\sum }_{l = {n}_{0}}^{j} M ( k , l ) , & i \geq j ; \\ {\sum }_{k = {n}_{0}}^{i} {\sum }_{l = j}^{{n}_{0} + n} M ( k , l ) , & otherwise .\end{matrix} \qquad ( 17 )$$

The following algorithm computes matrix T in using 2 (n+1)² additions, which is twice the number of elements in M and an n times better than n³/3+O(n²) additions required by the direct evaluation of the above definition.

Algorithm 5 (Computation of a matrix of tails: T := TT(M))

```
Given:
      A square matrix M(i,j), n₀ ≦ i,j ≦ n₀ + n.
Compute T(i,j) for i ≧ j:
      T(n₀ + n,n₀) = M(n₀ + n,n₀);
      for j = n₀ + 1 : n₀ + n
          T(n₀ + n,j) = T(n₀ + n,j − 1) + M (n₀ + n,j);
      }
      for i = n₀ + n − 1 : −1 : 1
          S1 = 0;
          for j = n₀ : n₀ + n
                S1 = S1 + M(i,j);
                T(i,j) = T(i + 1,j) + S1;
          }
      }
Compute T(i,j) for i < j:
      T(n₀,n₀ + n) = M(n₀,n₀ + n);
      for j = n₀ + n − 1 : −1 : n₀
          T(n₀,j) = T(n₀,j + 1) + M(n₀,j);
      }
      for i = 1 : n₀ + n − 1
          S1 = 0;
          for j = n₀ : −1 : i + 1
                S1 = S1 + M(i,j);
                T(i,j) = T(i − 1,j) + S1;
          }
      }
Output:  T.
```

The distribution calculated according to Algorithm 4 can be used for selection of rSNPs. Consider the log-rank function ρ(x) defined by Eq. (7) for the first allele. The function is monotonically non-decreasing, hence allows for an introduction of its “inverse” defined as follows:

$${ρ}^{- 1} ( y ) := {max}_{x ∈ \{ 0 , 1 , … , nU \}} ρ ( x ) \leq y , \qquad ( 13 )$$

for any y≧min_{xε{0, 1, . . . , U*}}ρ(x) and i:=min_{xε{0, 1, . . . , U*}}ρ(x), otherwise.

Let \vec{b}′, \vec{b}″ε [symbol] ⁿ be a wild type and its single substitution mutation, respectively, and

x′:=Sₙ(\vec{b}′) & x″:=Sₙ(\vec{b}″)

denote the corresponding scores (1) of a PWM. Define the p-value of central interest using the calibrating function ρ as defined by Eq. (7):

$$\begin{matrix}{p}_{val} ( {{b}^{->}}^{′} , {{b}^{->}}^{″} ) = {p}_{val} ( {{b}^{->}}^{′} , j , {b}^{″} ) ( 19 ) \\ := \{ \begin{matrix}P [ {X}^{′} \geq {x}^{′} \& ρ ( {X}^{′} ) - ρ ( {X}^{″} ) \geq ρ ( {x}^{′} ) - ρ ( {x}^{″} ) ] , & if {x}^{′} \geq {x}^{″} \text{:} \\ P [ {X}^{″} \geq {x}^{″} \& ρ ( {X}^{″} ) - ρ ( {X}^{′} ) \geq ρ ( {x}^{″} ) - ρ ( {x}^{′} ) ] , & otherwise .\end{matrix} \\ := \{ \begin{matrix}{P}_{( {{b}^{->}}^{′} , j . {b}^{″} )} [ {X}^{′} ( {{b}^{->}}^{′} ) \geq {x}^{′} \& ρ ( {X}^{′} ( {{b}^{->}}^{′} ) ) - ρ ( {X}^{″} ( {{b}^{->}}^{′} , j , {b}^{″} ) ) \geq ρ ( {x}^{′} ) - ρ ( {x}^{″} ) ] , & if {x}^{′} \geq {x}^{″} \text{:} ( 20 ) \\ {P}_{( {{b}^{->}}^{′} , j , {b}^{″} )} [ {X}^{″} ( {{b}^{->}}^{′} , j , {b}^{″} ) \geq {x}^{″} \& ρ ( {X}^{″} ( {{b}^{->}}^{′} , j , {b}^{″} ) ) - ρ ( {X}^{′} ( {{b}^{->}}^{′} ) ) \geq ρ ( {x}^{″} ) - ρ ( {x}^{′} ) ] , & otherwise .\end{matrix}\end{matrix}$$

The interpretation of this definition is straightforward. For instance, the first definition in (20) expresses the probability of a randomly selected pair (wild type, mutant) being at least as extreme as (\vec{b}′,\vec{b}″) in terms that: (i) the wild type allele has score not lower than that of \vec{b}′ and (ii) the drop in the log-rank ρ when changed to mutation allele is at least as large as for (\vec{b}′,\vec{b}″):

$$ρ ( {x}^{′} ) - ρ ( {x}^{″} ) = ρ ( {S}_{n} ( {{b}^{->}}^{′} ) ) - ρ ( {S}_{n} ( {{b}^{->}}^{″} ) ) = {log}_{10} \frac{{P}_{\vec{c}} [ {S}_{n} ( {c}^{->} ) \geq {S}_{n} ( {{b}^{->}}^{′} ) ]}{{P}_{\vec{c}} [ {S}_{n} ( {c}^{->} ) \geq {S}_{n} ( {{b}^{->}}^{″} ) ]} , \qquad ( 21 )$$

where we assume that \vec{c}ε [symbol] ⁿ is iid drawn from [symbol] .

In these terms pᵥₐₗ(\vec{b}′,\vec{b}″) is the probability of a mutation event (\vec{b}′,j,\vec{b}″) drawn from the above described distribution of mutations on [symbol] ⁿ×[1:n]× [symbol] such that the drop in its log-rank

$$\begin{matrix}ρ ( {X}^{′} ( {{b}^{->}}^{′} ) ) - ρ ( {X}^{″} ( {{b}^{->}}^{′} , j , {b}^{″} ) ) = ρ ( {S}_{n} ( {{b}^{->}}^{′} ) ) - ρ ( {S}_{n}^{( j )} ( {{b}^{->}}^{′} , j , {b}^{″} ) ) \\ = {log}_{10} \frac{{P}_{{c}^{->}} [ {S}_{n} ( {c}^{->} ) \geq {S}_{n} ( {{b}^{->}}^{′} ) ]}{{P}_{{c}^{->}} [ {S}_{n} ( {c}^{->} ) \geq {S}_{n}^{( j )} ( {{b}^{->}}^{′} , {b}^{″} ) ]}\end{matrix} \qquad ( 22 )$$

is at least as significant as for (\vec{b}′,\vec{b}″). Additionally, in the first definition of (20) the score for the wild type allele, X′(\vec{b}′)=Sₙ(\vec{b}′), is not smaller than x′=Sₙ(\vec{b}′).

The following theorem states that the pᵥₐₗ is a actually computable. Define the 2-dimensional matrix T(x₁,x₂) for x₁,x₂ε{0, 1, . . . , U*}:

$$T ( {x}_{1} , {x}_{2} ) := {\sum }_{{ξ}_{1} = {x}_{1}}^{{U}^{*}} {\sum }_{{ξ}_{2} = 0}^{{ρ}^{- 1} ( ρ ( {ξ}_{1} ) + ρ ( {x}_{2} ) - ρ ( {x}_{1} ) )} p * ( {ξ}_{1} , {ξ}_{2} ) , \qquad ( 23 )$$

if x₁≧x₂; otherwise, set:

$$T ( {x}_{1} , {x}_{2} ) := {\sum }_{{ξ}_{2} = {x}_{2}}^{{U}^{*}} {\sum }_{{ξ}_{1} = 0}^{{ρ}^{- 1} ( ρ ( {ξ}_{2} ) + ρ ( {x}_{1} ) - ρ ( {x}_{2} ) )} p * ( {ξ}_{1} , {ξ}_{2} ) . \qquad ( 24 )$$

Theorem 3: For any wild type n-mer allele \vec{b}′ε [symbol] ⁿ and its single nucleotide mutation \vec{b}″ε [symbol] ⁿ

pᵥₐₗ(\vec{b}′,\vec{b}″)=T(Sₙ(\vec{b}′),Sₙ(\vec{b}″)) (25)

### Results

The performance of the is-rSNP method exemplified in FIG. 3 is tested on two types of data. Firstly, a set of 41 known rSNPs (4 from the literature and 37 from OregAnno (Montgomery et. al., 2006)) is compiled for which there was empirical evidence showing the impact of the allelic variation on the binding of a functionally critical transcription factor. The steps in FIG. 3 are applied on each of these SNPs to determine if the correct TF was identified. We also analysed the same data using sTRAP (Manke et al., 2010) and compared the output with is-rSNP.

Secondly, 146 disease associated SNPs that had been classified as ‘intergenic’ are extracted from the Published Catalog of Genome-Wide Association Studies (Hindorff et al., 2010), and screened for potential rSNPs. The goal here was to see if the TF predicted by is-rSNP as being disrupted had prior evidence of being associated with the disease. If this association was present, it would suggest that the predicted rSNPs are likely to have a functional impact on the disease via a disease associated TF.

(a) Evaluating is-rSNP Using Known rSNPs

Table 1 shows the results of applying the is-rSNP method to 4 different rSNPs. Each of these rSNPs has previous empirical evidence to show that the nucleotide variation disrupts the binding of a particular transcription factor. is-rSNP was used to screen each SNP with all human PWMs in the TRANSFAC (Matys et. al., 2006) database. This resulted in a ranked list of PWMs that have a significant change in PWM score between the alleles. For each rSNP, the predictions were thresholded at Benjamini-Hochberg (BH)-corrected and are reported in Table 1 in FIG. 6(a).

In each of four cases there is a match between the predicted disrupted TF and the TF reported to be disrupted in the original studies (highlighted in bold). In the case of the fetal growth disorder rSNP (Demars et. al., 2010), and the blood pressure regulation rSNP (Funke-Kaiser et al., 2003), the most significant hit matches the reported TF. An interesting point to note is that there are multiple positive hits for OCT1, AP-2α and E2F2. This is due to the fact that many matrices are similar for the same TF family. These multiple matrices provide additional evidence for a bona fide binding site.

In addition to these 4 rSNPs, 37 known rSNPs extracted from OregAnno (Montgomery et. al., 2006) are also analysed. Out of those 41 (=4+37), 30 SNPs had the matching TF bound (PWM score BH-corrected) to one of the alleles, and in each of these cases a significant change in binding score was predicted by is-rSNP. Therefore is-rSNP correctly identified 30 out of the 41 known rSNPs.

Using the 41 known rSNPs, the utility of the output of is-rSNP is compared with that of sTRAP. To do this we compared the rank of the first correct prediction in the lists output by each algorithm for each SNP. The idea here is that the closer a correct prediction is to the top of the output list, the easier and more efficient it is to interpret and test predictions experimentally. The output of both algorithms is compared on only the 30 SNPs having scores with correct prediction.

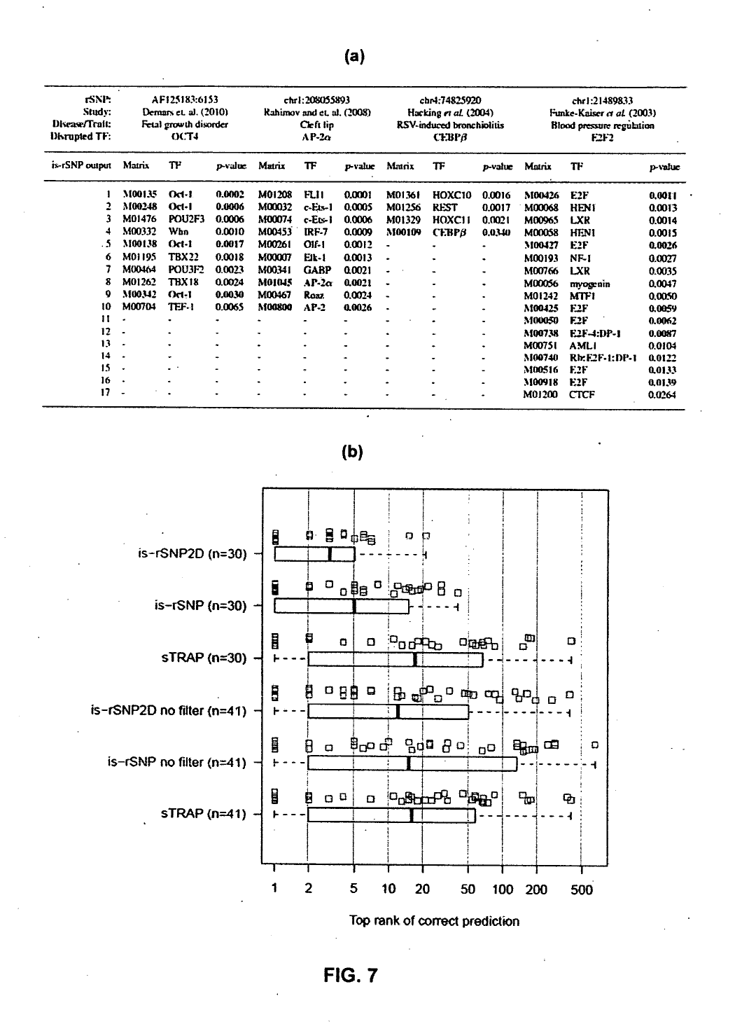

Referring now to FIG. 6(b), the results comparing the output of is-rSNP using the distribution of ratios, is-rSNP using the joint distribution (labelled “is-rSNP2D”) and sTRAP after analysis of 30 known rSNPs filtered for significant TF binding (i.e. having a PWM score with P≦0.001 for one of the alleles for the matching TF). It is shown in FIG. 7(b), that is-rSNP and is-rSNP2D consistently predict the correct TF at a better rank than sTRAP over the 30 SNPs (P<0.05, Mann-Whitney U test). In this graph, smaller values are better. The bold black line in the boxes represents the mean value of the top ranked correct predictions, the box edges represent the first and third quartile and the whiskers extend to the most extreme observation. In addition, each data point is plotted beneath its respective box plot, with jitter. Note that the x-axis is log scale.

In addition, the output a modified version of is-rSNP and is-rSNP2D without filtering steps 320 and 325 in FIG. 3 is compared with sTRAP output on 41 known rSNPs. In other words, the performance of is-rSNP, is-rSNP2D and sTRAP without a threshold and without binding site filtering is compared. Removing the filtering removes the requirement of the TF having to be significantly bound to at least one of the alleles. This allows comparison over all 41 SNPs; see box plots labelled as “is-rSNP2D no filter (n=41)”, “is-rSNP no filter (n=41)” and “sTRAP (n=41)” in FIG. 7(b). It is shown that is-rSNP and is-rSNP2D, output predictions at a better average rank than sTRAP over the 41 SNPs, albeit not consistently better. From the results, one can conclude that filtering of significant TF binding sites provides consistently more interpretable output through thresholding.

Moreover, a p-value rank according to at least one embodiment of is-rSNP has two main advantages over the log-ratio rank used by sTRAP: firstly, a log-ratio ranked list does not provide a sensible point of cut-off with respect to expected numbers of false positives, whereas p-value allows a cut-off with a known expected number of false positives; secondly, a p-value associated with each log-ratio facilitates interpretable output for multiple rSNP scanning. Using a p-value means that predictions across multiple SNPs can be combined into a single ranked list. This makes is-rSNP suitable for large-scale SNP screening.

(b) Searching for Candidate rSNPs in a Database of Disease Associated SNPs

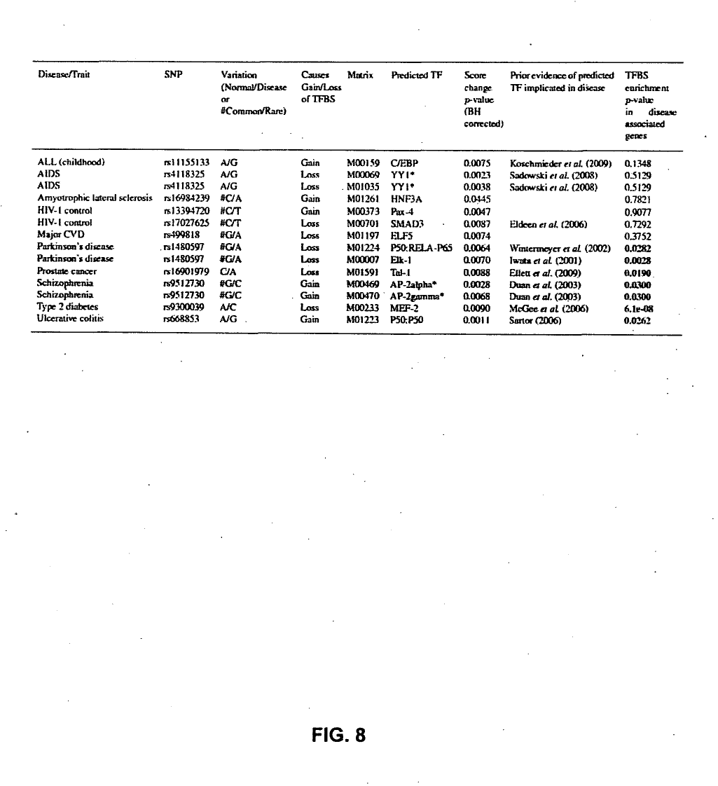

The Published Catalog of Genome-Wide Association Studies (Hindorff et al., 2010) contains a summary of disease and trait associated SNPs reported in the literature. Many of these, while shown to be strongly associated with the disease or trait, do not have any known functional relationship and are annotated as ‘intergenic’ (not being associated with a gene). It is possible that many of these SNPs are rSNPs. Therefore we used is-rSNP to predict TF binding sites that are likely to be disrupted using 146 ‘intergenic’ of these disease associated SNPs. Out of the 146, 11 SNPs were predicted to have a significant (P<0.01) impact on a TF binding site. These predictions are reported in Table 2, the last column; see FIG. 8.

Table 2 provides a summary of the results output when is-rSNP was used to identify candidate rSNPs in a set of intergenic disease associated SNPs. Only results that show a significant (BH-corrected P<0.01) change in TF binding affinity between the alleles are included. Columns 1-2 provide information about the disease and associated SNP. Columns 3-4 state the base change between normal and disease state and whether this results in a loss or gain in binding site. Columns 5-7 outline the TF predicted to be disrupted by the allele and the p-value associated with the change. Column 8, if present, contains a reference to prior evidence that the predicted TF is known to be associated with the disease. The final column provides the p-value of the enrichment of TF binding sites around genes shown to be differentially expressed in the disease.

To test if these predictions were likely to be biologically relevant, we looked for evidence in the literature that the TF predicted had prior evidence of being associated with the disease. 8 out of the 11 predicted rSNPs showed prior evidence that the disrupted TF plays a role in the disease. In addition, we also used expression profiling of each of the diseases, to see if genes differentially expressed in the disease were enriched for binding sites of the predicted TF. The enrichment, if shown, would provide additional evidence that the predicted TF plays a critical role in the disease and the rSNP is therefore likely to be the causal SNP. In 7 cases genes differentially expressed in the disease had binding site enrichment for the disrupted TF.

### (c) Discussions

Personalized medicine aspires to develop a panel of targeted drugs that can correct imbalances in biochemical and cell biological processes that lead to disease states. For example, cancers that arise from BRCA1 mutations are specifically prone to PARP-inhibitors. To exploit disease-associated SNPs to derive novel drug targets, insight to the mechanistic link between the allelic variation and the disease is required. This link is particularly difficult to derive when a SNP is positioned between genes. Also, attenuating progress in the field is the immense difficulty to functionally validate the biological impact of single base substitution in a regulatory element in the genome, as knock-in experiments are very expensive and labour intensive.

Thus, identifying in silico means to assess the likelihood of allelic variation to impact the function of a given transcription factor on a specific target gene could accelerate the progress from GWAS to personalized medicine. In at least one embodiment, the is-rSNP method offers to capitalize on the central dogma of transcription regulation, and identify novel links between targetable transcription factors and disease states, if their cognate binding to critical targets in the genome is affected by the DNA sequence variation. In this case, it is shown here that in at least one embodiment, it is possible with high degree of confidence to identify novel transcription factor-disease links through the comparison of the allelic variation with the sequence constraints of all known transcription factors.

Beyond reproducing 30 validated cases, 11 such links are identified (see Table 2 in FIG. 8, threshold P<0.01) from among 146 published disease associated SNPs, 9 for which the disrupted TFs is reported associated with the disease in the literature. Following on from these significant predictions, further rSNPs for the same disease and same TF may be identified.

Only 5 of the 11 SNPs in Table 2 showed both forms evidence of the predicted disrupted TF being associated with the disease. This is not unexpected as most of the GWAS studies use bulk genotyping arrays, therefore it is likely that the reported disease associated SNP is not in fact the causative SNP, but rather belongs to the same linkage-disequilibrium block as the causative SNP. In this case, it may be sensible to process not only the disease associated SNP with is-rSNP, but neighbouring SNPs as well. As mentioned previously, many of the matrices in TRANSFAC are similar or duplicated amongst TFs and TF families. This results in severe multiple testing correction to p-values when scanning multiple SNPs with a database of PWMs. If a non-redundant database can be used, this may result in many more significant rSNP predictions.

Also, the method could be employed on more empirically derived TF-binding datasets than TRANSFAC (Matys et. al., 2006), such as ChIP-Seq data, or a panel of 500 protein bound DNA elements, derived from in vivo by digital genomic footprinting (Hessel berth et al., 2009). Focusing on regions of chromatin histone modifications, potentially indicative of regulatory modules (Hon et al., 2009; Won et al., 2009; Visel and et. al., 2009), may also improve predictions.

For example, it is found that of the 11 disease-associated SNPs reported in Table 2, 9 are overlapping with tri-methylated lysine 27 of histone H3, a histone mark that represents chromatin silencing events, related to progenitor-differentiation axis, and regulated by polycomb group proteins. This unexpected result may represent some so far unappreciated gradient of penetrance of alleles, based on their chromatin accessibility, such as the case with imprinting, where only one of the copies of DNA is available to transcription factor binding (and the impact of a rare allele on phenotype would be pseudo haplotype). Whatever the mechanistic basis for the H3K27Me3 link with disease associated intergenic SNPs, this information may become useful for future versions of is-rSNP and for genotyping projects that use massively parallel sequencing. The data presented here offers numerous novel links between known, and in most cases targetable, transcription factors and specific cohorts of patients for defined disease, each of which becomes a hypothesis basis for novel clinical trials of personalized medicine.

In addition, a major contingency in the interpretation of intergenic SNPs, which is the identification of the target gene responsible for the control of the disease, may be assisted by the knowledge of which TF binding is affected by the rSNP. Within any region in the genome among neighbouring genes there is likely a known target of a TF, implicating that target gene in the control of the disease, even when there is a large distance between the rSNP and the target (Fullwood et. al., 2009). Of course further validation of the methodology is required before patients are addressed with novel drugs, but the method clearly deserves more investigation and development. In its current form, it is suitable for screening large sets of potential rSNPs, and provides output which can be interpreted with an idea of the statistical significance of each predicted rSNP.

In at least one embodiment, the is-rSNP method is distinguishable over previous attempts at finding rSNPs that have relied largely on prediction of transcription factor (TF) binding sites that overlap SNPs (Ponomarenko and et. al., 2001). This approach typically produces large numbers of false positives, as many SNPs will not significantly alter the binding affinity of a TF given the degenerate nature of TF binding sites.

Also, in at least one embodiment, the is-rSNP method is also distinguishable over an approach that studies the difference in binding site score between two alleles using a PWM (Andersen et. al., 2008). The reasoning here is that SNPs generating ‘larger’ PWM score differences are considered more likely to be rSNPs than those generating ‘smaller’ differences. However, as PWM scores can differ based on not only the length of the binding site, but the degeneracy at each position, considering the magnitude of score difference between alleles will favour short PWMs with low degeneracy, thus penalising long, degenerate PWMs.

Further, the is-rSNP method is distinguishable over an approach that looks at normalising the score distributions of PWMs so that observed changes were comparable between PWMs (Manke et al., 2010). In this case, the PWM scores are not used directly, but a modified affinity score is used to represent the binding affinity. A Fourier transform is used to calculate the complete distribution of affinity scores, consequently allowing the computation of p-value for observed scores. The ratio of p-values of affinity scores between two alleles can then be used to determine if the TF binding site is likely to be disrupted. This approach is shown to be successful through comparison against a set of known rSNPs and a large list of PWMs ranked by the log ratio of the score p-values is shown. Unfortunately in this case, there is no clear way of an appropriate cut-off point to distinguish true and false prediction. This makes interpretation of results difficult, especially when screening large numbers of SNPs.

Rather than using affinity scores, at least one embodiment of the method uses scores generated from the PWM directly. This facilitates a simple and efficient approach for calculating the distribution PWM scores via direct computation of convolution. This method also allows the computation of distributions of p-value ratios. By obtaining this distribution, the significance of a single base change on the binding affinity of a TF can be determined, rather than simply report the ratio of p-values as in Manke et al. (2010). By associating a p-value with the ratio, the method can determine smaller, significant sets of predicted disrupted TF binding sites and provide significance scores of results across a large number of SNPs.

### Additional Examples

### Distribution of Quantised Ranks

In yet another embodiment, the distribution of all scores calculated in step 315 in FIG. 3 may be further improved. The computation of pᵥₐₗ given by Theorem 3 requires the knowledge and storage of at least one of the two U*×U* matrices: p*(x′,x″) and T(x′,x″). This may cause some practical problems and is in practise not necessary. Accordingly, simplification along the lines taken in Algorithm 1 which relies on storage of much smaller matrices may be used.

The key observation is that pᵥₐₗ as defined in Eqs. 19-20 is actually determined by the values of log-ranks ρ(x′) and ρ(x″), where ρ is a monotonically non-decreasing function with non-negative values. The first step is to compute a distribution of quantised log-ranks:

(\vec{b}′,j,\vec{b}″) [symbol] (\vec{b}′,\vec{b}″) [symbol] ([ρ∘Sₙ(\vec{b}′)]_{δ},[ρ∘Sₙ(\vec{b}″)]_{δ})=([ρ∘X′(\vec{b}′)]_{δ},[ρ∘X″(\vec{b}′,j,\vec{b}″)]_{δ}).

Algorithm 6: Computation of Distribution of Quantised Log-ranks

```
Given:
1.  A prior probability distribution [p(b)] on [symbol]   := {1, 2, 3, 4};
2.  A mutation distribution [pₘ(b′,b″)], where b′,b″ ε [symbol]  ;
3.  A PWM [w(b,i)]_{4×n} with non-negative integer values ≦ U;
4.  A constant δ > 0.
Initialise  :
5.  Use Algorithm 1 to compute the distribution of scores [p_{*}(x)]_{x=0,1,...,U*}
6.  Set V := [ − log₁₀minp_{*}(x)]_{δ};
7.  Joint probability distribution p_{*δ}(v′,v″) := 0 for v′,v″ ε [0 : V].
Compute the joint probability distribution p_{*δ}(v′,v″):
8.  for i = 1 : n
9.  Use Algorithm 1 to compute the distribution [p_{*0}(x)]_{x=1,2,...,U}₀* of
      scores Σ_{j≠i} w(bⱼ,j) of the reduced PWM with i-th column
      neglected;
10.  for x = 0 : min ((i − 1)U,U₀*)
11.  for b′ = 1 : 4
12.  x′ = x + w(b′,i);
13.  v′ = ρ_{δ}(x′);
14.  for b″ = 1 : 4
15.  x″ = x + w(b″,i);
16.  v″ = ρ_{δ}(x″);
17.  set p_{*δ}(v′,v″) ← p_{*δ}(v′,v″) + p_{*0}(x)p(b′)pₘ(b′,b″);
            }
        }
      }
    }
Output:  p_{*δ} ← p_{*δ}/n .
```

The following theorem states that the pᵥₐₗ can be approximated given the distribution of quantized log-ranks p*δ.

### Theorem 4

P[p_{δ}(X′)=v′,ρ_{δ}(X″)=v″]p_{*δ}(v′,v″),

for any v′,v″ε[0:V].

Define T_{δ}:=TT(p_{*δ}), where function TT is defined in Eq. (17). The 2 dimensional matrix for v′,v″ε{0, 1, . . . , V} satisfies the following form of Eq. (17):

$${T}_{δ} ( {υ}^{′} , {υ}^{″} ) = \{ \begin{matrix}{\sum }_{{v}_{1} = {v}^{′}}^{V} {\sum }_{{v}_{2} = 0}^{{v}^{″}} p * δ ( {υ}_{1} , {υ}_{2} ) , & if {υ}^{′} \geq {υ}^{″} ; \\ {\sum }_{{v}_{1} = 0}^{v} {\sum }_{{v}_{2} = {v}^{″}}^{V} p * δ ( {υ}_{1} , {υ}_{2} ) , & otherwise .\end{matrix} \qquad ( 26 )$$

Theorem 5: Given a wild type n-mer allele \vec{b}′ε [symbol] ⁿ and its single nucleotide mutation \vec{b}″ε [symbol] ⁿ. Let v′:=(Sₙ(\vec{b}′)) and v″:=(Sₙ(\vec{b}″)). If v′≧v″, then

T_{δ}(v′+1,v″−1))≦pᵥₐₗ(\vec{b}′,\vec{b}″)≦T_{δ}(v′−1,v″+1)); (27)

otherwise, v′<v″ and

T_{δ}(v′−1,v″+1))≦pᵥₐₗ(\vec{b}′,\vec{b}″)≦T_{δ}(v′+1,v″−1)). (28)

These results show that knowledge of the matrix T_{δ}=TT(p_{*δ}) is sufficient for practical computation of pᵥₐₗ.

### Similarity of Two PWMs

In another example, the statistical similarity of PWMs may be defined using the joint distribution of scores of two PWMs in FIG. 4(b). There are a number of challenges here:
The algorithm below is for the computation of a distribution for PWMs that are aligned with each other. Finding such an alignment in the first place could be a challenging task, but generally in the worst case, the number of candidate alignments need to be evaluated is, in practice, no more than the size of the PWM. One expects that many of such alignments can be dismissed easily using straightforward heuristics.
There is no assumption that the coefficients of PWMs are mutually adjusted. To circumvent this issue, it is assumed that two functions ρ₁ and ρ₂ for calibrating score of the PWMs are given. The natural candidates for such calibrations are the rank calibration function introduced by Eq. (5).
In contrast to the case of substitution mutation where the iteration were on one dimensional vector of distribution (see p_{*0} in Algorithm 4), in the current situation each stage needs to be iterated over a 2-dimensional matrices. This may impact on efficiency of computations (note that potentially millions of pairwise PWM similarities needs to be evaluated). This could be addressed by development of simpler to evaluate upper bounds.

The idea of statistical similarity between two PWMs is that they bound to the identical or at least similar DNA n-mers. This can be interpreted as that the same set of sites both PWMs allocate the similarity high scores, or that the differences between calibrated scores are minimal in the area of top scoring sites. The example of a function measuring such a similarity and defined as an expectation of a conditional probability distribution follows:

$${C}_{{v}_{0}} := {𝔼}_{{b}^{->} \sim {𝔹}^{n}} [ \frac{{( {v}_{1} - {v}_{2} )}^{2}}{{( {v}_{1} + {v}_{2} )}^{2}} \vert max ( {v}_{1} , {v}_{2} ) \geq {v}_{0} \& {v}_{j} := {ρ}_{j} ( {S}_{j} ( {b}^{->} ) ) , j = 1 , 2 ] , \qquad ( 29 )$$

where S₁ and S₂ denote scores for our two PWMs, respectively, and v₀ε [symbol] . Evaluation of this definition depends on the knowledge of joint distribution of scores (v₁,v₂)=(ρ₁S₁,ρ₂S₂).

Algorithm 7 (Joint Distribution of Scores of two PWMs)

```
Given:
1.  A prior probability distribution [p(b)] on [symbol]   := {1, 2, 3, 4};
2.  Two PWM [wⱼ(b,i)]_{4×n} with non-negative integer values ≦ U for
  j = 1, 2.
Initialise:
3.  U* := Σᵢ₌₁ⁿ max_{b,j} wⱼ(b,i), (≦ nU);
4.  p_{*}(x₁,x₂) := 0 for x₁,x₂ = 0, 1,..., U*.
5.  for b = 1 : 4
6.  xⱼ = ρⱼ(wⱼ(b, 1)) for j = 1, 2
7.  set p_{*}(x₁,x₂) ← p_{*}(x₁,x₂) + p(b);
8.  }
9.  for i = 2 : n
10.  p_{*}′(x₁,x₂) := 0 for x₁,x₂ = 0, 1,..., U*.
11.  for x₁ = 0 : min ((i − 1)U, U*)
12.  for x₂ = 0 : min ((i − 1)U, U*)
13.  for b = 1 : 4
14.  xᵢ′ = xⱼ + wⱼ(b,i) for j = 1, 2;
15.  set p_{*}′(x₁′,x₂′) ← p_{*}′(x₁′,x₂′) + p_{*}(x₁,x₂)p(b);
            }
        }
    }
16.  set: p_{*} = p_{*}′;
    }
Output:  p_{*}.
```

It should also be understood that, unless specifically stated otherwise as apparent from the following discussion, it is appreciated that throughout the description, discussions utilizing terms such as “receiving”, “processing”, “retrieving”, “selecting”, “calculating”, “determining”, “displaying”, “detecting”, “generating” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices. Unless the context clearly requires otherwise, words using singular or plural number also include the plural or singular number respectively.

It should also be understood that the techniques described might be implemented using a variety of technologies. For example, the “processing unit” described may be implemented by software, hardware or a combination of both. Further, the method(s) described herein may be implemented by a series of computer executable instructions residing on a suitable computer readable medium. Suitable computer readable media may include volatile (e.g. RAM) and/or non-volatile (e.g. ROM, disk) memory, carrier waves and transmission media (e.g. copper wire, coaxial cable, fibre optic media). Exemplary carrier waves may take the form of electrical, electromagnetic or optical signals conveying digital data streams along a local network or a publicly accessible network such as the Internet.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

### REFERENCES

Andersen, M. C. et. al., P. G. E. (2008). In silico detection of sequence variations modifying transcriptional regulation. PLoS Comput Biol, 4(1), e5.
Benjamini, Y. and Hochberg, Y. (1995). Controlling the false discovery rate: A practical and powerful approach to multiple testing. Journal of the Royal Statistical Society. Series B (Methodological), 57(1), 289-300.
Clayerie, J. and Audic, S. (1996). The statistical significance of nucleotide position weight matrix matches. Bioinformatics, 12(5), 431.
Crooks, G. E., Hon, G., Chandonia, J., and Brenner, S. E. (2004). WebLogo: a sequence logo generator. Genome Research, 14(6), 1188-1190.
Demars J. D. et. al. (2010). Analysis of the IGF2/H19 imprinting control region uncovers new genetic defects, including mutations of OCT-binding sequences, in patients with 11p15 fetal growth disorders. Hum. Mol. Genet, 19(5), 803-814.
Duan, J., et. al. (2003). Polymorphisms in the 5[prime]-untranslated region of the human serotonin receptor 1B (HTR1B) gene affect gene expression. Mol Psychiatry, 8(11), 901-910.
Eldeen, M. B., et. al. (2006). MH2 domain of smad3 reduces HIV-1 tat-induction of cytokine secretion. Journal of Neuroimmunology, 176(1-2), 174-180.
Ellett, F., Kile, B. T., and Lieschke, G. J. (2009). The role of the ETS factor erg in zebrafish vasculogenesis. Mechanisms of development, 126(3-4), 220-229.
Fullwood, M. J. et. al. (2009). An oestrogen-receptor-alpha-bound human chromatin interactome. Nature, 462(7269), 58-64.
Funke-Kaiser, H., et. al. (2003). Differential binding of transcription factor E2F-2 to the endothelin-converting enzyme-1b promoter affects blood pressure regulation. Human Molecular Genetics, 12(4), 423-433.
Hacking, D., et. al. (2004). Increased in vivo transcription of an IL-8 haplotype associated with respiratory syncytial virus disease-susceptibility. Genes and Immunity, 5(4), 274-282.
Hesselberth, J. R., et. al. (2009). Global mapping of protein-DNA interactions in vivo by digital genomic footprinting. Nat Meth, 6(4), 283-289.
Hindorff, L., Sethupathy, P., Junkins, H., Ramos, E., Mehta, J., Collins, F., and Manolio, T. (2010). A catalog of published Genome-Wide association studies.
Hon, G., Wang, W., and Ren, B. (2009). Discovery and annotation of functional chromatin signatures in the human genome. PLoS Comput Biol, 5(11), e1000566.
Iwata, A., Miura, S., Kanazawa, I., Sawada, M., and Nukina, N. (2001). alpha-Synuclein forms a complex with transcription factor elk-1. Journal of Neurochemistry, 77(1), 239-252.
Koschmieder, S., Halmos, B., Levantini, E., and Tenen, D. G. (2009). Dysregulation of the C/EBP differentiation pathway in human cancer. Journal of Clinical Oncology, 27(4), 619-628.
Manke, T., Heinig, M., and Vingron, M. (2010). Quantifying the effect of sequence variation on regulatory interactions. Human Mutation, 31(4), 477-483.
Matys et. al., V. M. (2006). TRANSFAC and its module TRANSCompel: transcriptional gene regulation in eukaryotes. Nucleic acids research, 34(Database issue), D108-10.
McGee, S. L. and Hargreaves, M. (2006). Exercise and skeletal muscle glucose transporter 4 expression: molecular mechanisms. Clinical and Experimental Pharmacology & Physiology, 33(4), 395-399.
Montgomery, et. al., S. B. M. (2006). ORegAnno: an open access database and curation system for literature-derived promoters, transcription factor binding sites and regulatory variation. Bioinformatics, 22(5), 637-640.
Pisinger, D. (1999). Linear time algorithms for knapsack problems with bounded weights. Journal of Algorithms, 33(1), 1-14.
Ponomarenko, J. V. and et. al. (2001). rSNP Guide, a database system for analysis of transcription factor binding to target sequences: application to SNPs and sitedirected mutations. Nucl. Acids Res., 29(1), 312-316.
Rahimov, F, and et. al. (2008). Disruption of an AP-2[alpha] binding site in an IRF6 enhancer is associated with cleft lip. Nat Genet, 40(11), 1341-1347.
Sadowski, I., Lourenco, P., and Malcolm, T. (2008). Factors controlling chromatin organization and nucleosome positioning for establishment and maintenance of HIV latency. Current HIV Research, 6(4), 286-295.
Sartor, R. B. (2006). Mechanisms of disease: pathogenesis of crohn's disease and ulcerative colitis. Nature Clinical Practice. Gastroenterology & Hepatology, 3(7), 390-407.
Touzet, H. and Varre, J.-S. (2007). Efficient and accurate p-value computation for position weight matrices.
Visel, A. and et. al. (2009). ChIP-seq accurately predicts tissue-specific activity of enhancers. Nature, 457(7231), 854-858.
Wintermeyer, P., Riess, O., Schls, L., Przuntek, H., Miterski, B., Epplen, J. T., and Krger, R. (2002). Mutation analysis and association studies of nuclear factorkappaB1 in sporadic parkinson's disease patients. Journal of Neural Transmission (Vienna, Austria: 1996), 109(9), 1181-1188.
Won, K., Agarwal, S., Shen, L., Shoemaker, R., Ren, B., and Wang, W. (2009). An integrated approach to identifying Cis-Regulatory modules in the human genome. PLoS ONE, 4(5), e5501.

1. A computer-implemented method for detecting a regulatory single nucleotide polymorphism (rSNP), comprising:
(a) determining a first score representative of a transcription factor binding affinity of a first allele, and a second score representative of a transcription factor binding affinity of a second allele,
wherein the first and second alleles are associated with a single nucleotide polymorphism (SNP), and the first score differs from the second score representing a change in the transcription factor binding affinity;
(b) determining a statistical significance value of the change in transcription factor binding affinity represented by the first score and the second score; and
(c) comparing the statistical significance value with a threshold to determine whether the SNP is an rSNP.

2. The method of claim 1, wherein the statistical significance value of the change in transcription factor binding affinity in step (b) represents a statistical significance of observing a ratio between a statistical significance value of the first score and a statistical significance value of the second score.

3. The method of claim 2, wherein the statistical significance of observing the ratio is determined using a distribution of ratios of statistical significance values of all scores.

4. The method of claim 3, further comprising calculating or retrieving the distribution of ratios of statistical significance values of all scores prior to step (b).

5. The method of claim 1, wherein the first score is greater than the second score.

6. The method of claim 1, wherein the statistical significance value of the change in transcription factor binding affinity in step (b) represents a statistical significance of observing the first score and the second score on a two-dimensional, joint distribution of first and second scores.

7. The method of claim 6, further comprising calculating the two-dimensional, joint distribution of first and second scores prior to step (b).

8. The method of claim 7, wherein the two-dimensional joint distribution is calculated using mutation probabilities representative of biases of mutation preferences from the first allele to the second allele.

9. The method of claim 8, wherein the mutation probabilities follow a probability distribution of observing the second allele.

10. The method of claim 8, wherein the mutation probabilities follow a probability distribution with equal probabilities of observing different nucleotides.

11. The method of claim 6, wherein the two-dimensional, joint distribution captures statistical similarity of the first score and the second score.

12. The method of claim 4, wherein the distribution is calculated using direct computation or convolution.

13. The method of claim 12, wherein the distribution is calculated recurrently using multiple iterations where a partial sum of the distribution is calculated at each iteration.

14. The method of claim 1, wherein step (b) is performed only if the higher value between a first statistical significance value of the first score and a second statistical significance value of the second score satisfies a predetermined threshold of statistical significance.

15. The method of claim 1, wherein the first and second scores are each determined using a position weight matrix (PWM) associated with the first and second alleles.

16. The method of claim 15, wherein the first score and the second score are determined using a sum of weights, each weight is associated with a base at a position in the first or second allele.

17. The method of claim 16, wherein the weights are absolute frequencies of the base at the position, relative frequencies or a transformation of the absolute or relative frequencies.

18. The method of claim 1, further Comprising repeating steps (a), (b) and (c) for one or more other pairs of first and second alleles, and ranking each pair of first and second allele according to respective statistical significance value of the change in transcription factor binding affinity.

19. A computer program comprising machine-executable instructions to cause a computer system to perform a method for detecting a regulatory single nucleotide polymorphism (rSNP), comprising:
(a) determining a first score representative of a transcription factor binding affinity of a first allele, and a second score representative of a transcription factor binding affinity of a second allele
wherein the first and second alleles are associated with a single nucleotide polymorphism (SNP), and the first score differs from the second score representing a change in the transcription factor binding affinity;
(b) determining a statistical significance value of the change in transcription factor binding affinity represented by the first score and the second score; and
(c) comparing the statistical significance value with a threshold to determine whether the SNP is an rSNP.

20. A computer system for detecting a regulatory single nucleotide polymorphism (rSNP), comprising a processing unit operable to:
(a) determine a first score representative of a transcription factor binding affinity of a first allele, and a second score representative of a transcription factor binding affinity of a second allele,
wherein the first and second alleles are associated with a single nucleotide polymorphism (SNP), and the first score differs from the second score representing a change in the transcription factor binding affinity;
(b) determine a statistical significance value of the change in transcription factor binding affinity represented by the first score and the second score; and
(c) compare the statistical significance value with a threshold to determine whether the SNP is an rSNP.
